(19) United States
(12) Patent Application Publication
(10) Pub. No.: US 2006/0202791 A1
(43) Pub. Date: Sep. 14, 2006

(54) Resettable over-current protection device and method for producing the like

(76) Inventors: Chang-Wei Ho, Ruetfang Township (TW); Yung-Yi Chang, Chung Li City (TW); Shang-Chi Chuang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/075,697

(22) Filed: Mar. 10, 2005

(51) Int. Cl. H01C 7/13

(52) U.S. Cl. 338/22 R; 338/220

(57) ABSTRACT

A resettable power surge protector and a method for producing the like are described. The method prepares a laminated body with separation groves in an alternating manner for defining chip devices, provides two end terminals attached to the laminated body, and arranges two insulative sheets covering the uppermost and lowermost surfaces of the laminated body. The laminated body has at least two conductive polymeric sheets, at least one inner electrode sheet arranged between the two conductive polymeric sheets, and upper and lower outer electrode sheets disposed under and below the two conductive polymeric sheets, respectively. The two end terminals wrap the lateral sides of the curved sidewalls of the laminated body for electrically connecting the inner electrode sheet, upper and lower outer electrode sheets alternatingly. The protection device is formed with lateral curved sides, being symmetrical to each other due to the correspondence with the two lateral curved sidewalls.

### BACKGROUND OF THE INVENTION

1. Field of the Invention

The present invention relates to a resettable over-current protection device and a method for producing the like, and particularly relates to a resettable over-current protection device, which contain a polymeric material with positive temperature coefficient for producing a thermal resistor of positive temperature coefficient and a method for producing the like.

2. Description of Related Art

The polymeric-based thermal resistor of positive temperature coefficient, known as PPTC, is composed of conductive grains, generally black carbons, metallic powders, and conductive particles, polymeric-based materials and some additives. An increase in temperature or current raises the resistance of PPTC thermistor, and this additional resistance in the circuit has the effect of reducing the overall current. Once the over current situation has been removed the PPTC thermistor cools down; in doing so its internal temperature drops, resulting in the resistance returning to a low state. Therefore, the PPTC thermistor is also called a resetable fuse, which means a polymer device switches the current on or off, and is widely applied to protect against overcurrent or shorts in small electric equipment. In addition, the PPTC thermistor is used to protect, for example, computer peripheral equipment, such as USB ports, telecommunication and network equipment, secondary rechargeable batteries, such as battery packs, power sources, and automobiles, such as mobile starters. With respect to FIG. 1, the principle of the operation behind the PPTC thermistor, at the normal temperature, the polymeric-based materials in crystalline phase and regular structure have conducting chains of the conductive grains, and thus have low resistance, such as below 100 ohms, 10 ohms or even 1 ohm, for smoothly conducting electricity by contact between each of the conductive grains such as, for example, black carbons, without changing the crystalline structure where the polymeric molecules form. As the temperature increases while the current rises, the polymeric-based materials maintain this structure but eventually transition suddenly to an amorphous phase where the molecules are aligned randomly due to the excessive heat. Volume increases and the conductive grains are broken and separated from each other, in order to increase the resistance and return the current back to a low state for overcurrent protection in a very short time. When the temperature drops or the current decreases, the polymeric-based materials return to the crystalline phase, the volume diminishes, and the conductive grains contact to form the conducting chains again. Thus, the resistance of the PPTC thermistor returns to the low state. The concept of the PPTC thermistor obeys the law of the conservation of energy; the heat caused by the increase of the resistance thereof dissipates into the surrounding environment or adds to the temperature thereof. The temperatures of points 1 and 2 illustrated in FIG. 1, indicates a kind of equilibrium between the surrounding environment and the PPTC thermistor during the normal range of the current or the temperature thereof. When the current or the temperature exceeds a critical value, at point 3 in FIG. 1, a little change of temperature can lead to a dramatic increase in resistance around that state. Once the temperature exceeds point 3, the PPTC thermistor trips so as to increase the resistance thereof rapidly to point 4 in FIG. 1 for restricting the current and protecting the related equipment.

Generally, the PPTC thermistor is manufactured by providing the exclusive ingredient, which includes polymers, conductive grains and additives. The ingredient is mixed and processed as a sheet. Two metallic foils, generally nickel foils, nickel-plated copper foils or copper-nickel alloy foils, sandwich the sheet. Upper and lower electrodes are made via further processes, and a PPTC thermistor is provided. The characteristic of the PPTC thermistor corresponds to the ingredient thereof, and relates to the initial resistance, the trip capability and the reversibility, so that the ingredient is the top secret in each manufacture. However, the resistance of the PPTC thermistor corresponds to not only the crystalline structure of polymers and the density of the conductive grains, but also the thickness of the sheet and the overlapping area between the two outermost electrodes. In addition, the combination between the electrodes and the polymer sheet, the attachment of the end terminals, the internal stresses after producing, and the practicability and reliability for the client are considerations in the processes.

For meeting requirements, such as slight, short, lightweight and thin, the size of SMD type device improves from the specifications of 0603, 0402 to even 0201. The PPTC thermistors with higher resistance cannot enlarge their planer area, for example, lengthwise or widthways, and are replaced by raising the thickness in a stack manner, for the increase of the resistance via the parallel connection by the multilayer arrangement. Compared with the single-layer PPTC thermistor, the multilayer PPTC thermistor is provided with higher capacity of the working current (that means higher trip capacity), and furthermore, the surface area on the PCB of the multilayer PPTC thermistor is much less than that of the single-layer PPTC thermistor. The disadvantage of the stack management is that the heat due to the end terminals will be increasingly apparent as the layers are increasingly stacked. Excessive heat has hazards of tripping the PPTC thermistor, and the heat stress by residual heat influences the reliability thereof. Conventional technologies cannot resolve the problems of the heat cluster completely.

With respect to FIGS. 2A to 2F, U.S. Pat. No. 6,348,852, the first prior art, discloses at least three nickel-plated copper foils 1a formed with a plurality of comb-figured grooves 10a in advance, and at least two PTC polymer sheet 2a alternatingly laminated by the three foils 1a. The grooves 10a, arranged on a respective one of the foils 1a and formed with gaps from an opposite one of end terminals, are opposite and overlapped with those on an adjacent one of the foils 1a (in FIG. 2a). The sheet after the sandwich process is further diced with a plurality of openings 11a, which are narrow and long to penetrate through the sheet and alternates with the grooves 10a (in FIG. 2B). A layer of protection coat 4a, epoxy acrylic resin, is provided to cover the grooves 10a by a screen-printing process, but partially expose the tooth part (in FIG. 2C). The semi-finished product is further electroplated with the nickel layer, which cover the external surfaces of the outermost foils la and the inner surfaces of the openings 11a (in FIG. 2D). After the nickel-plating process, the sheet is diced as a plurality of chip devices (in FIG. 2E). The openings 11a of the PPTC thermistor chip illustrated in FIG. 2E are processed via the dicing blade to form a straight line. Corresponding to the relation between the resistance and the overlapped area, the larger the overlapping area is, the less resistance is. An overlapping area of the first prior art, circumscribed by the straight-line geometry of the openings 11a and the grooves 10a, is small due to a wasted area near the end terminals. If the designed overlapping area is small, the corresponding resistance value becomes large, and the margin to trip decreases because that the trip current value decided by the ingredient of the sheet is fixed, so as to narrow the application thereto.

Referring to FIGS. 3A to 3G, U.S. Pat. No. 6,242,997, the second prior art discloses two nickel plates 1b laminated with PPTC material 2b therein as a sheet (in FIG. 3C) in the first step. At least two sheets are etched with a plurality of leaner interior isolation gaps 10b, respectively. With the exception of the external nickel plate 1b of the outermost sheet, the gaps 10b, illustrated in FIG. 3B′, arranged on a respective nickel plate 1b of the sheet, from an opposite one of end terminals, are opposite and overlapping those on an adjacent sheet (in FIGS. 3A and 3B). The sheet is penetrated with a plurality of passageways 11b (in FIG. 3D) and further electroplated with the copper layer 3b into the passageways 11b and onto the outermost nickel plates 1b, so that the nickel plates 1b connect electrically with one another in an alternating manner via the copper layer 3b (in FIG. 3E). Each of the two outermost nickel plates 1b is etched with one separation slot 12b for dividing the copper layer 3b into upper and lower electrodes (in FIG. 3F), and covered with a protection coat 4b for enclosing the separation slot 12b (in FIG. 3G). Finally, the tin layer 5b is electroplated on the copper layer 3b (in FIG. 3H), and the finished sheet can be diced into PPTC thermistor chips (in FIG. 3I). As in the first prior art, a overlapping area of the second prior art, circumscribed by the straight-line geometry of the upper and lower separation slots 12b, is small due to a wasted area near the end terminals. If the designed overlapping area is small the corresponding resistance value becomes large, and the margin to trip decreases because the trip current value decided by the ingredient of the sheet is fixed, thus narrowing application thereof. In addition, electroplating the copper layer 3b and the tin layer 5b inside the passageways 11b forms the end terminal in the second prior. The cross-sectional surface of the end terminal is too small, due to each passageway, 11b to provide good solderability, so that de-wetting and component lifting problems, which seriously affect the practicability and the reliability in clients, occur during the reflow process.

Referring to FIGS. 4A to 4F, U.S. Pat. No. 6,188,308, the third prior art discloses at least three copper foils 1c laminated with at least two PPTC sheets 2c therein in an alternating manner as a laminated sheet (in FIGS. 4A and 4B). The laminated sheet is penetrated with a plurality of axle holes 11c (in FIG. 4C), and further plated with a layer of nickel with 10-20 micrometers first and a layer of copper with 10-20 micrometers then. Inside the axle holes 11c and outside the two copper foils 1c are covered with the nickel-copper layer 4c (in FIG. 4D), in order to connect electrically the two copper foils 1c to each other. A separation slot 12c of each copper foil 1c with the nickel-copper layer 4c is etched (in FIG. 4E), and a protection coat 5c corresponding to a predetermined pattern is covered on each copper foil 1c for enclosing the separation slot 12c (in FIG. 4F). Excluding the designated area covered by the protection coat 5c, the laminated sheet is further plated with a layer of nickel 6c (in FIG. 4G) and finally divided into PPTC thermistor chips (in FIG. 4H). The separation slot 12c, which is curved, utilizes more area near the end terminals, but the end terminal thereof is still formed by plating the nickel-copper layer 4c and the nickel 6c onto each axle hole 11c for electrical connection. This structure of the end terminal similar to that of the second prior art, and the cross-sectional surface of the end terminal fails to provide good solderability, so that the de-wetting and component lifting problems, which seriously affect the practicability and the reliability in clients, occur during the reflow process. Furthermore, the axle hole 11c causes difficulty in the electroplating therein to lower fineness requirements on the end terminal; the reduced fineness makes the joint between the nickel-copper layer 4c and the nickel 6c crack and peel, or the components crack due to the unbalanced inner stresses after the reflow process. The cross-sectional surface of each axle hole 11c is too small to apply to the PCB normally, because the current on the PCB is easily chokes by the small surfaced axle hole 11c. The heat due to the current choke will increase the hazard of tripping before a real over current, and this will absolutely diminish the practicability and the reliability in clients.

### SUMMARY OF THE INVENTION

A resettable over-current protection device and a method for producing the like according to the present invention is provided to improve the heat conductivity and heat dissipation capacity, so as to prevent effects of the characteristic and application thereof from the induced heat due to the environment and the error design.

A resettable over-current protection device and a method for producing the like according to the present invention is to keep the effective area overlapped by the upper and lower outer electrode sheets. The larger the effective area is, the less the resistance of the device is, so that the margin for tripping is larger and the application of the device is wider.

A resettable over-current protection device and a method for producing the like according to the present invention avoids internal stresses residual in the device from the crack thereof.

A resettable over-current protection device and a method for producing the like according to the present invention is to increase the plate and solder surface area for good solderability without de-wetting, component lifting and similar problems.

A resettable over-current protection device according to the present invention is described as follows. A laminated body includes at least two conductive polymeric sheets, at least one inner electrode sheet arranged between the two conductive polymeric sheets, and upper and lower outer electrode sheets disposed under and below the two conductive polymeric sheets, respectively. The laminated body has two lateral curved sidewalls symmetrical to each other, and the two conductive polymeric sheets are characterized with positive temperature coefficient. Two end terminals wrap the lateral sides of the curved sidewalls of the laminated body, and electrically connect the inner electrode sheet, upper and lower outer electrode sheets in an alternating manner. Two insulative sheets cover the uppermost and lowermost surfaces of the laminated body and fill between the two end terminals. The upper and lower outer electrode sheets have lateral curved sides symmetrical to each other due to the correspondence with the two lateral curved sidewalls.

A method for producing resettable over-current protection device according to the present invention is described as follows:

(a) A laminated sheet is prepared, which is formed first by pressing at least two conductive polymeric sheets alternatingly with at least one inner electrode sheet, and then, providing upper and lower outer electrode sheets disposed under and below the two conductive polymeric sheets respectively. The upper, lower outer electrode sheets and the inner electrode sheets are etched with a plurality of separation grooves, respectively, which are curved and discontinuous. The separation grooves alternate at the upper, lower outer electrode sheets and the inner electrode sheets in order to define a plurality of chip devices.

(b) A plurality of lines are pre-cut corresponding to a predetermined pattern on each of the upper and lower outer electrode sheets. The lines have a plurality of continuous longitudinal curves and a plurality of discontinuous horizontal beelines, and each of the continuous longitudinal curves is symmetric to a neighboring one.

(c) Two insulative sheets are coated on to cover the upper and lower outer electrode sheets of the laminated sheet, and enclose a respective uppermost one and a lowermost one of the separation grooves.

(d) The laminated sheet is segmented into a plurality of chip devices. Each of the chip devices has two lateral curved sidewalls symmetrical to each other.

(e) Each of the chip devices is electroplated as two end terminals attached to the two lateral curved sidewalls thereof, for electrically connecting the inner electrode sheet, upper and lower outer electrode sheets in an alternating manner.

A method for producing resettable over-current protection device according to the present invention is described as follows:

(a) A laminated sheet is prepared, which is formed first by pressing at least two conductive polymeric sheets alternating with at least one inner electrode sheet, and then, providing upper and lower outer electrode sheets disposed under and below the two conductive polymeric sheets respectively. THE upper, lower outer electrode sheets and the inner electrode sheets are etched with a plurality of separation grooves, respectively, which are curved and discontinuous. The separation grooves alternate at the upper, lower outer electrode sheets and the inner electrode sheets in order to define a plurality of chip devices.

(b) A plurality of drilling holes penetrate through the laminated sheet corresponding to a predetermined pattern.

(c) Two insulative sheets are coated on, covering the upper and lower outer electrode sheets of the laminated sheet, and enclosing a respective uppermost one and a lowermost one of the separation grooves;

(d) The laminated sheet is segmented into a plurality of chip devices. Each of the chip devices has two lateral drilled surfaces symmetrical to each other.

(e) Each of the chip devices is electroplated as two end terminals attached to the two lateral curved sidewalls thereof, for electrically connecting the inner electrode sheet, upper and lower outer electrode sheets in an alternating manner.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a characteristic plot of PPTC thermistor;

FIGS. 2A to 2E are the perspective views corresponding to the processes for producing a PPTC thermistor of the first prior art;

FIGS. 3A to 3I are the perspective views corresponding to the processes for producing a PPTC thermistor-of the second prior art;

FIGS. 4A to 4H are the perspective views corresponding to the processes for producing a PPTC thermistor of the third prior art;

FIG. 5A is a perspective view of a resettable over-current protection device according to a first embodiment of the present invention;

FIG. 5B is a top view of the resettable over-current protection device according to the first embodiment of the present invention;

FIG. 6A is a perspective view of the resettable over-current protection device according to a second embodiment of the present invention;

FIG. 6B is a top view of the resettable over-current protection device according to the second embodiment of the present invention;

FIG. 7 is a flow chart of a method for producing resettable over-current protection device according to the present invention;

FIGS. 8A to 8K, and FIG. 8X are the perspective views corresponding to a first embodiment according to the first embodiment of the present invention;

FIGS. 9A to 9F are the perspective views corresponding to the method of a second embodiment according to the present invention; and

FIGS. 10A to 10J, and FIG. 10H′ are the perspective views corresponding to the method of a third embodiment according to the present invention.

### DETAILED DESCRIPTION OF PREFERRED EMBODIMENTS

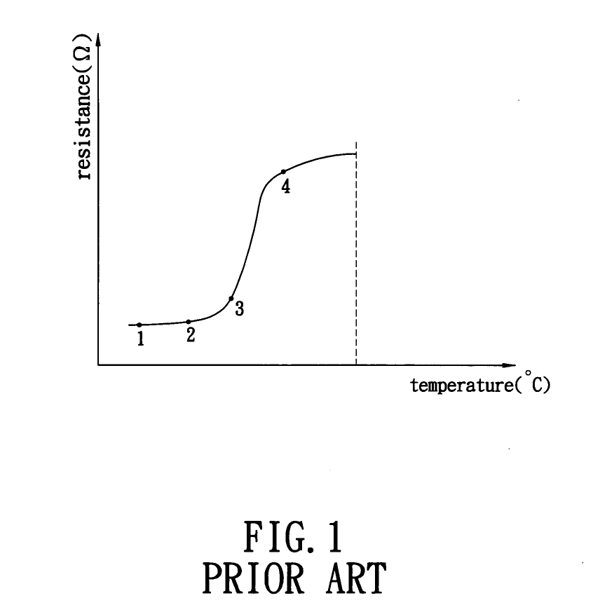

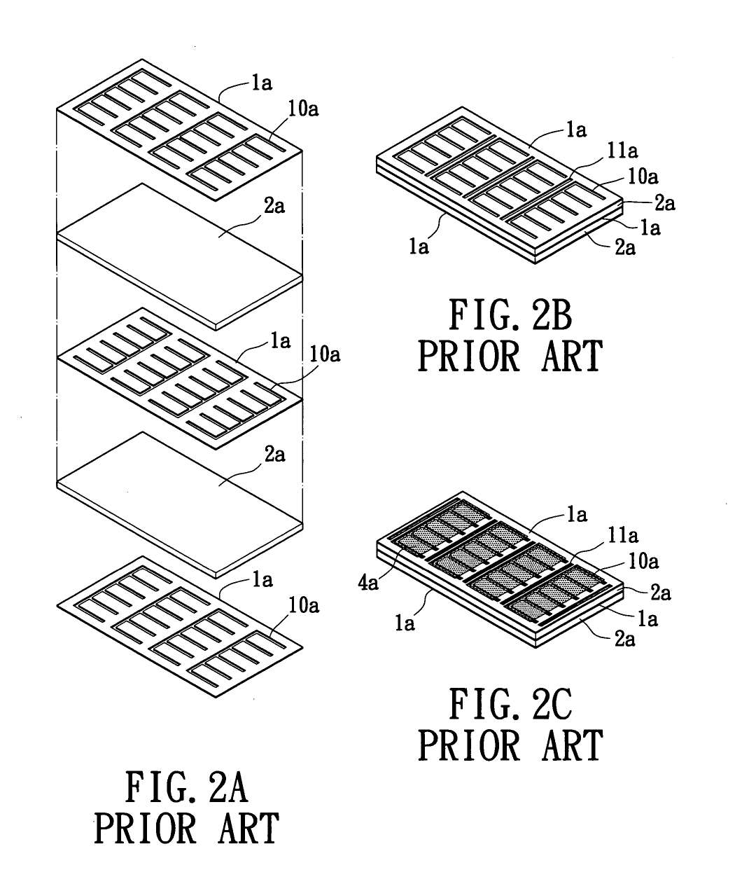

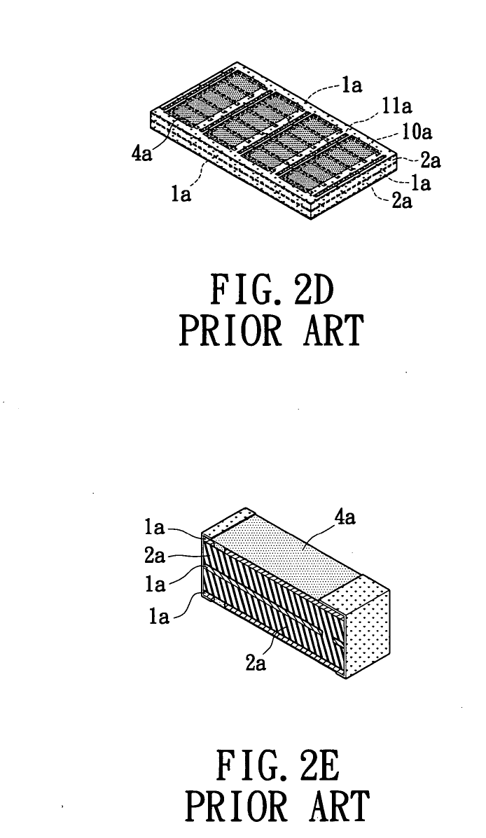

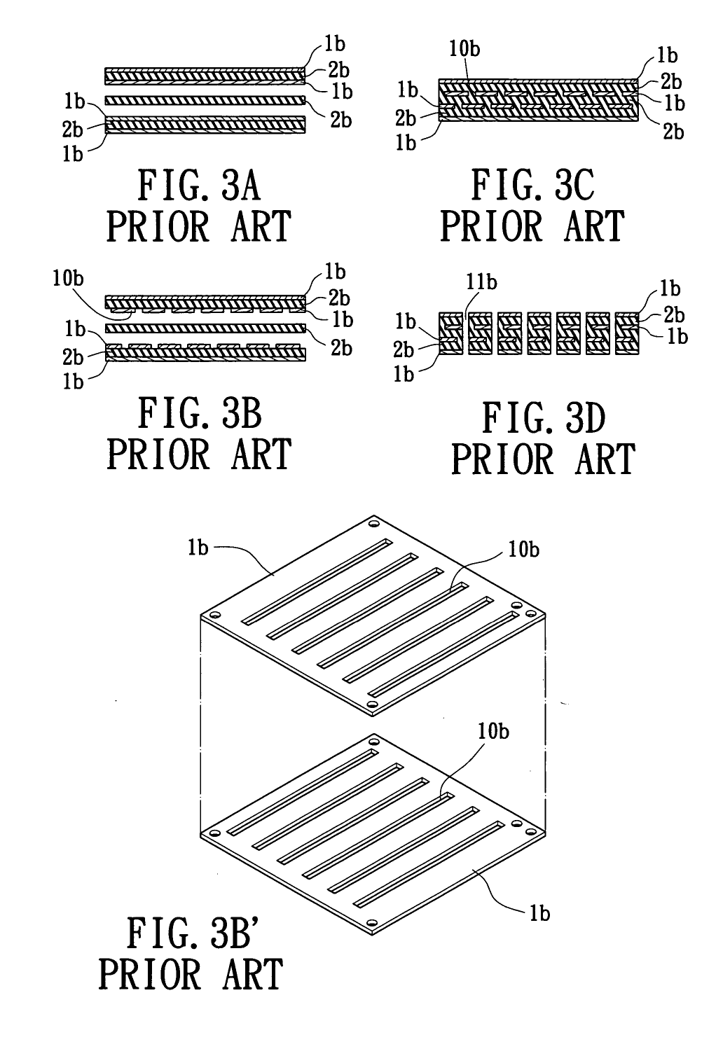

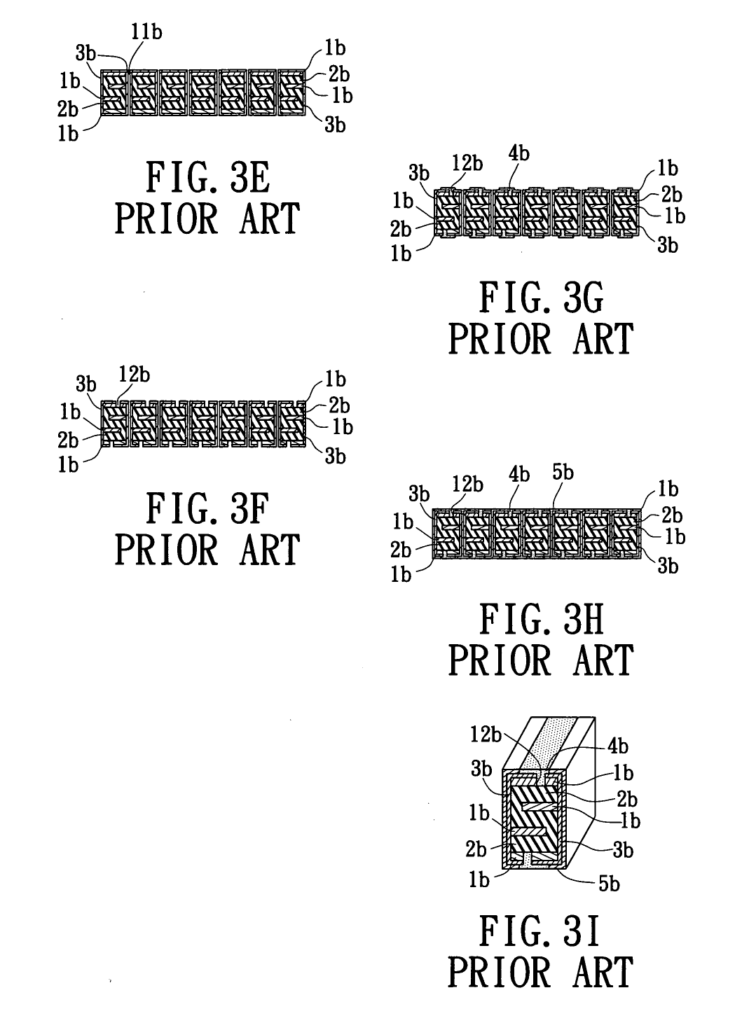

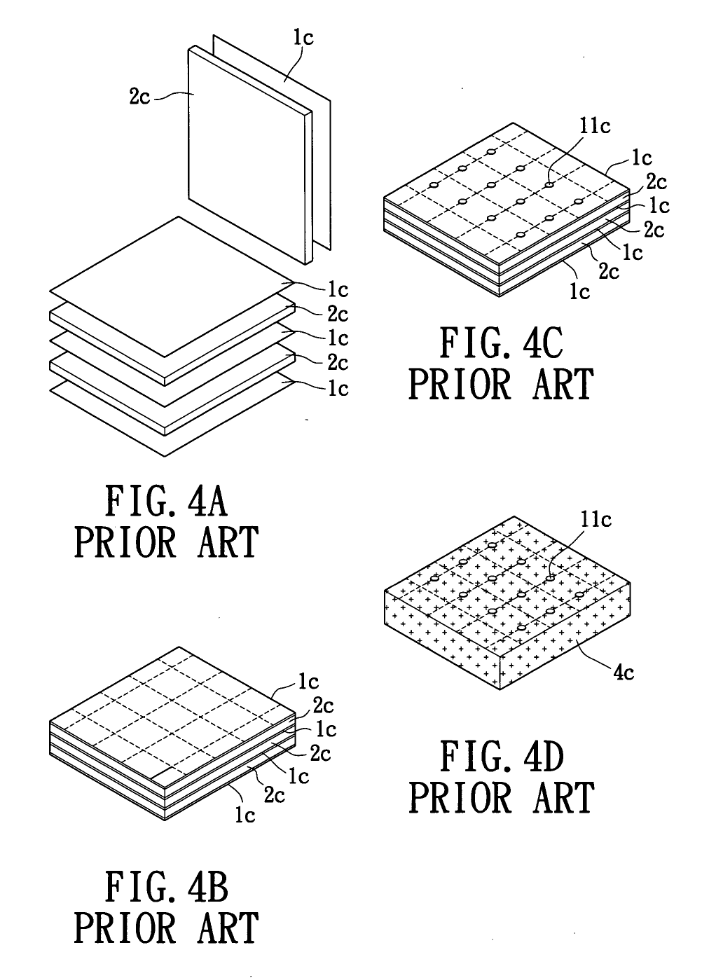

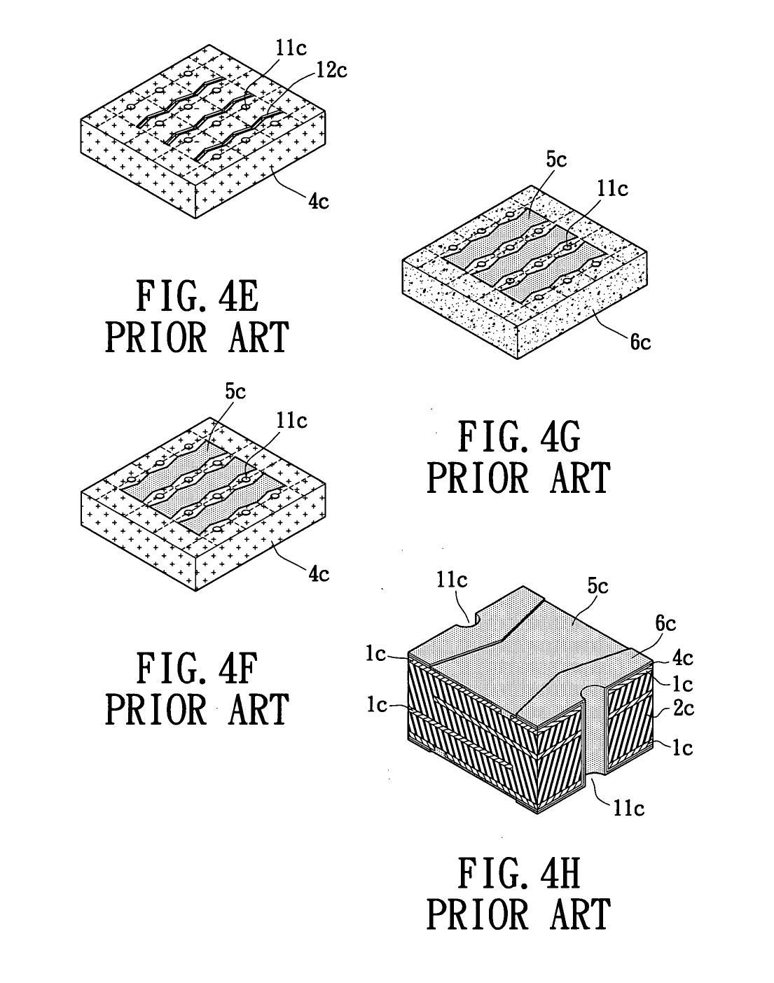

As illustrated in FIG. 1, the PTC polymer materials of the PPTC thermistor are in an amorphous phase from a crystalline phase when a over current or excessive heat occurs. The resistance of the PPTC thermistor increases in several seconds for a trip or open state to restrain the current flow and protect the circuit. After the over current or excessive heat disappears, the resistance returns to the low state. This is known as “resetable”. As the wrong design of the PPTC thermistor, particular a multilayered thermistor via stack manufactures, or the high temperature of the environment, the PPTC thermistor stores up the heat and is easily tripped to shut down the operation of the relative circuit. Therefore, a resettable over-current protection device and a method for producing the like according to the present invention improve the heat conductivity and the heat dissipation without the effects of the environment temperature and the wrong design.

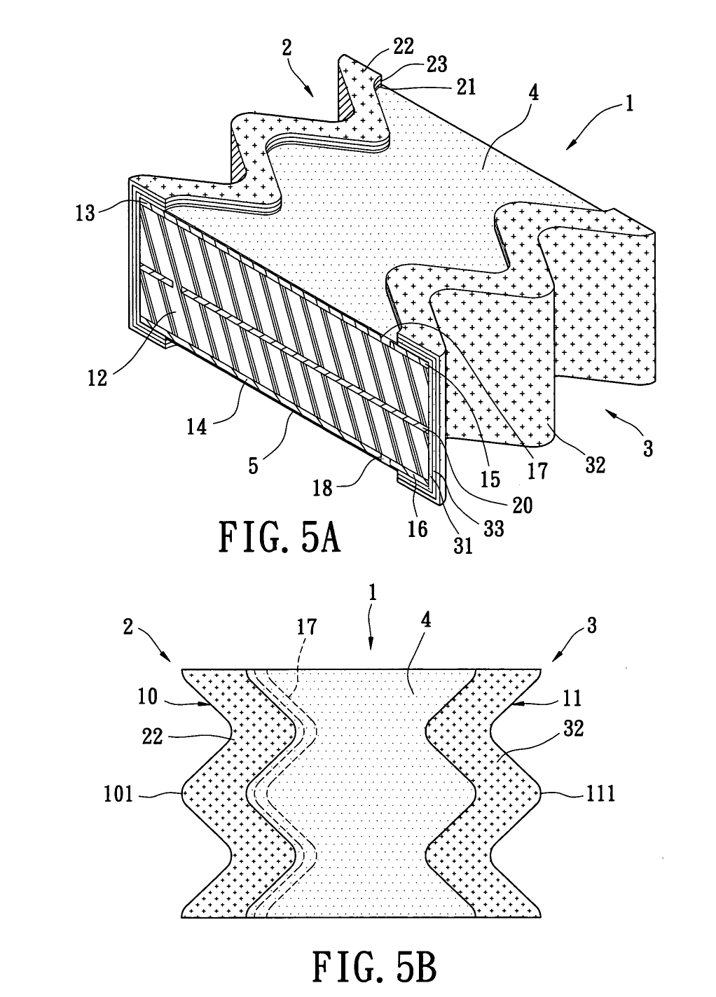

With respect to FIGS. 5A and 5B, a resettable over-current protection device includes a laminated body 1 with two lateral curved sidewalls 10, 11 symmetrical to each other, two end terminals 2, 3 wrapping the lateral sides of the curved sidewalls 10, 11 of the laminated body 1, and two insulative sheets 4, 5 covering the uppermost and lowermost surfaces of the laminated body 1 and filling between the two end terminals 2, 3.

The laminated body 1 includes at least two conductive polymeric sheets 12 with a positive temperature coefficient for determining the resistance, the trip capacity and the resettability, at least one inner electrode sheet 20 arranged between the two conductive polymeric sheets 12, upper and lower outer electrode sheets 13, 14 disposed under and below the two conductive polymeric sheets 12, respectively, and upper and lower conductive sheets 15, 16 disposed under and below the two conductive polymeric sheets 12, respectively. The upper outer electrode sheet 13 is isolated from the upper conductive sheets 15 via an upper separation groove 17 formed therebetween, the lower outer electrode sheet 14 is isolated from the lower conductive sheets 16 via a lower separation groove 18 formed therebetween, and the inner electrode sheet 20 is divided into two parts via another separation groove for isolation. In accordance with the present embodiment, the left end terminal 2 electrically connects the two outer electrode sheets 13, 14 and a part of the inner electrode sheet 20, and the right end terminal 3 electrically connects the two conductive sheets 15, 16 and the other part of the inner electrode sheet 20 simultaneously. Thus, each of the conductive polymeric sheets 12 has two electrodes disposed thereon and isolated from each other. The upper outer electrode sheet 13 is formed from the left curved side 10 and extends inwardly to approach the upper conductive sheet 15; the lower outer electrode sheet 14 is formed from the left curved side 10 and extends inwardly to approach the lower conductive sheet 16. The lateral sides of the two outer electrode sheets 13, 14 correspond to the curved sides 10, 11 of the laminated body 1 and are symmetrical to each other. Therefore, the two outer electrode sheets 13, 14 and the inner electrode sheet 20 can form the effective area with the largest overlap under the same chip size, such 0603, 0201 and so on, so as to broaden the application of the resettable over-current protection device. The two insulative sheets 4, 5 enclose the separation grooves 17, 18 and fill between the two end terminals 2, 3. The two outer electrode sheets 13, 14, the two conductive sheets 15, 16 and the inner electrode sheet 20 are made of nickel, copper, nickel-plated copper foil, or copper-nickel alloy materials. Each of the two end terminals 2, 3 includes at least two electroplated layers, of which an outermost layer, a second electroplated layer 22, 32, is made of tin material for solder. An innermost layer, a first electroplated layer 21, 31, thereof is made of copper or nickel materials. In this embodiment, each of the two end terminals 2, 3 includes three electroplates layers, the first layer 21, 31 is made of copper materials, and a further third electroplated layer 23, 33, which is made of nickel materials formed between the first and the second electroplated layers 21, 31 and 22, 32.

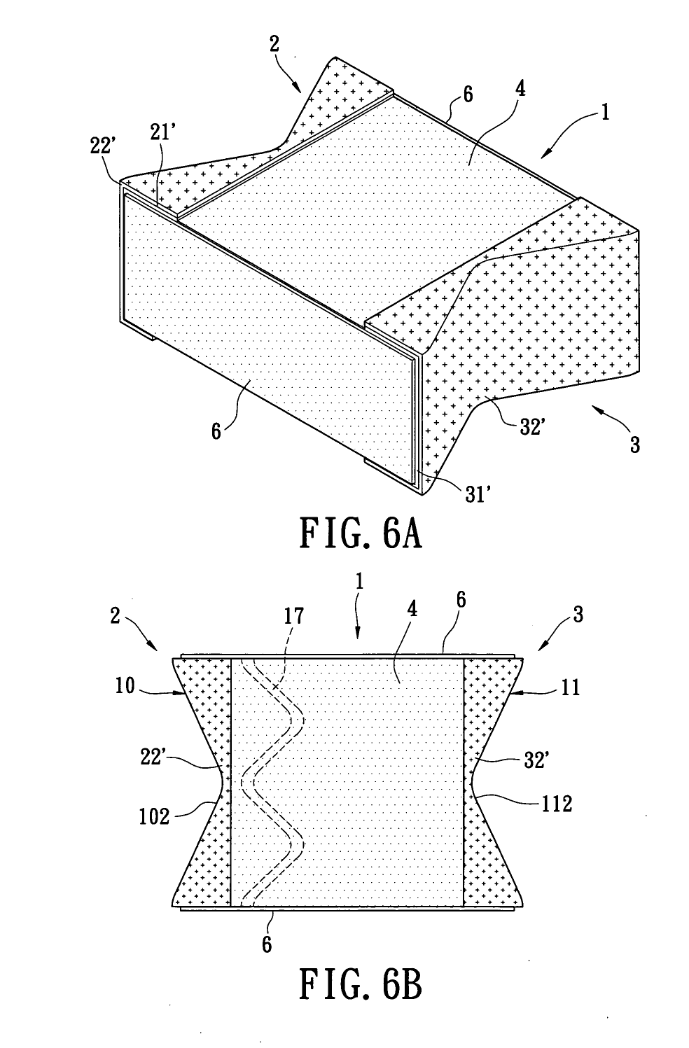

FIG. 6A illustrates at least one concave portion 102, 112 formed on each of the two lateral curved sidewalls 10, 11. In the mentioned embodiment, each of the two lateral curved sidewalls 10, 11 may have a continuous concave-convex portion 101, 111. The variation of each lateral curved sidewall 10, 11 can enlarge the surface area under the same chip size. In an electroplating process, the enlarged surface area is helpful for plating efficiency and fineness; in a soldering process, the enlarged surface area is helpful for solderability without de-wetting and lifting. In addition, the lateral curved sides 10, 11 of the laminated body 1 should be symmetrical because the force to grab the solder should be equal; if the residual inner stresses after the solder process can be avoided, the component will not crack.

Similar to FIGS. 5A and 5B, the two outer electrode sheets 13, 14, the two conductive sheets 15, 16 and the inner electrode sheet 20 are made of nickel, copper, nickel-plated copper foil, or copper-nickel alloy materials. Each of the two end terminals 2, 3 includes at least two electroplated layers, of which an outermost layer, a second electroplated layer 22, 32, is made of tin material for solder. An innermost layer, a first electroplated layer 21, 31, thereof is made of copper or nickel materials depending on the ingredients of the two outer electrode sheets 13, 14, the two conductive sheets 15, 16. In this embodiment, each of the two end terminals 2, 3 includes three electroplates layers, the first layer 21, 31 is made of copper materials, and a further third electroplated layer 23, 33, which is made of nickel materials formed between the first and the second electroplated layers 21, 31 and 22, 32. FIG. 6B illustrates only two electroplated layers constructed as the lateral end terminals 2, 3, each first electroplated layer 21′, 31′ is plated with nickel materials, and each copper layer 22′, 32′ disposed on the respective electroplated layer 21′, 31′.

The two insulative sheets 4, 5, made of liquid photoimagible solder mask (LPSM) inks, illustrated in FIG. 5A, are configured with curves corresponding to the curved sides 10, 11. In FIG. 6A, another embodiment of the two insulative sheets 4, 5, which can be printed thereon with straight line, is illustrated, because the purpose of the arranged of the insulative sheets 4, 5 is to fill inside the separation grooves 17, 18 to isolate any two adjacent electrode sheets from each other.

Referring to FIG. 6B, the laminated body 1 further includes two insulative walls 6, which can be also made of liquid photoimagible solder mask (LPSM) inks, coated in a front and a rear thereof, respectively, for isolating any two adjacent electrode sheets from each other. On the contrary, FIG. 5B shows the laminated body 1 without any insulative wall 6 because the isolation between any two adjacent electrode sheets can be practiced by controlling the current density in the electroplating process, and the polymer sheets 12 and the insulative sheets 4, 5 can be excluded for plating.

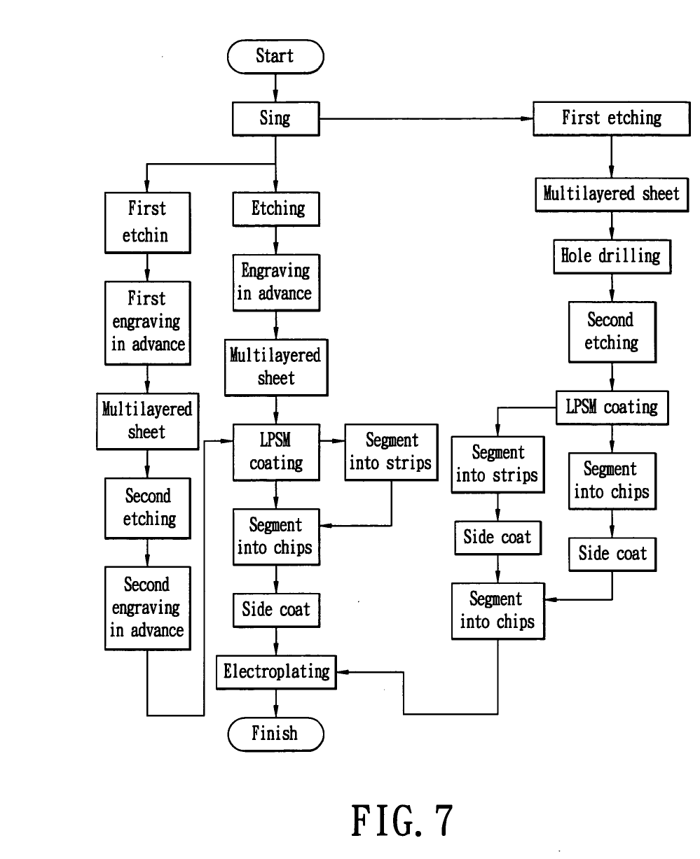

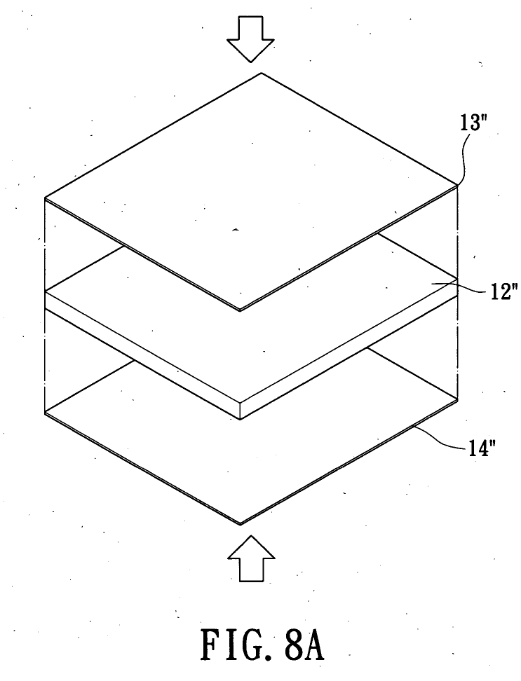

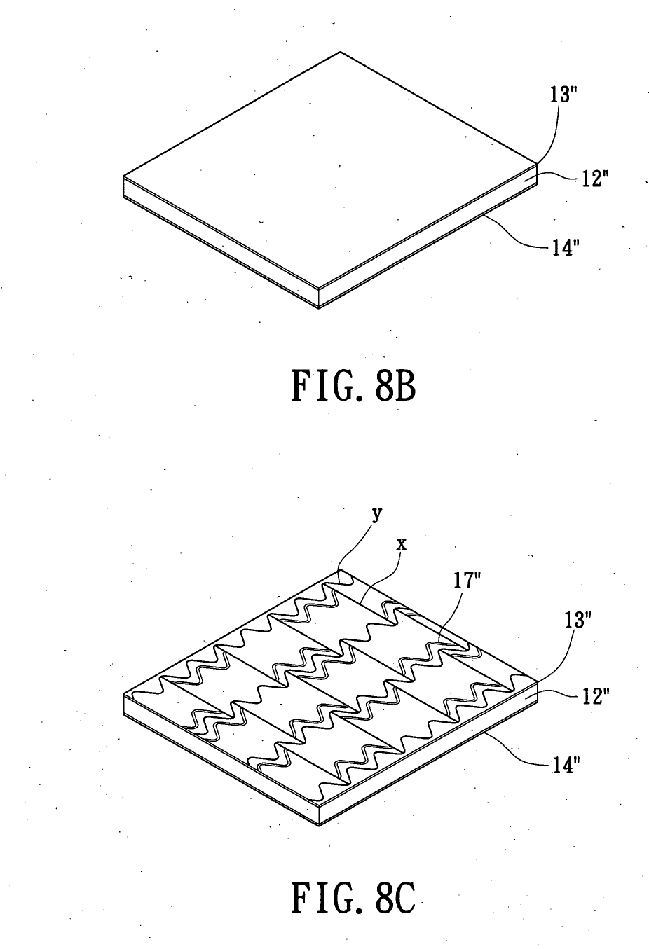

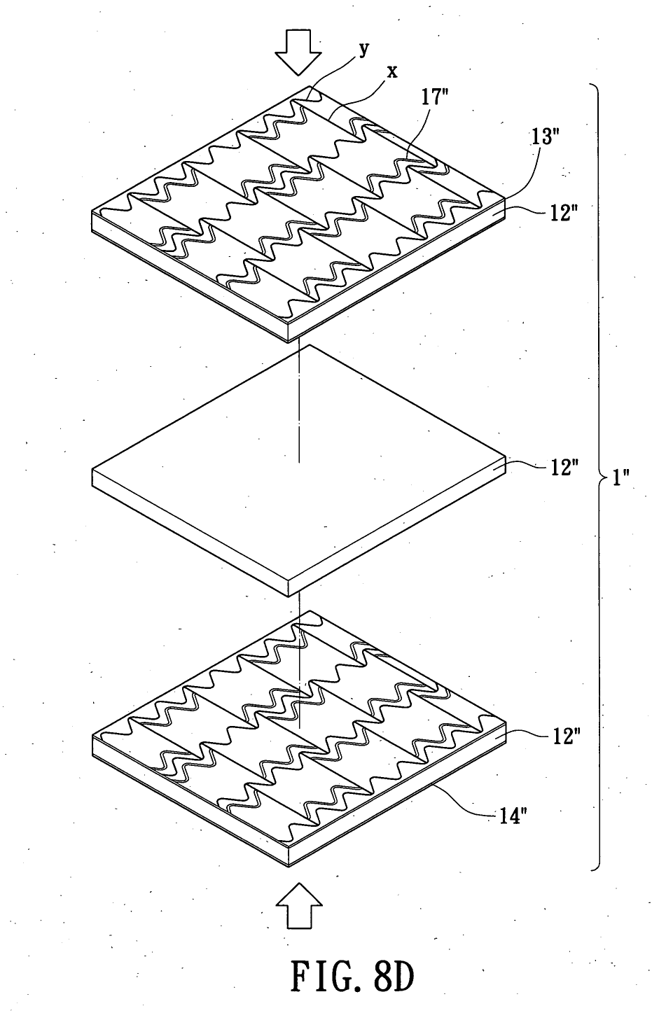

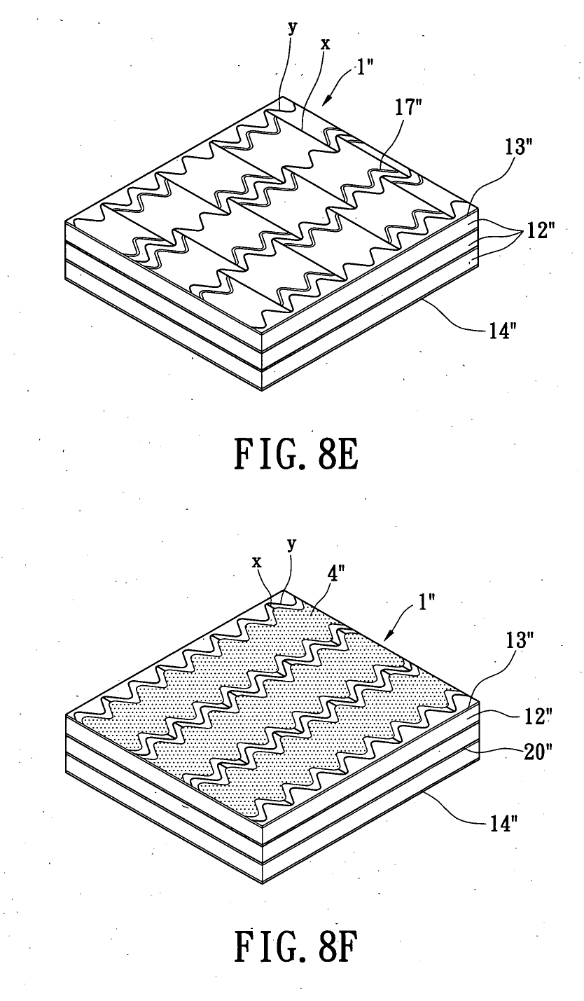

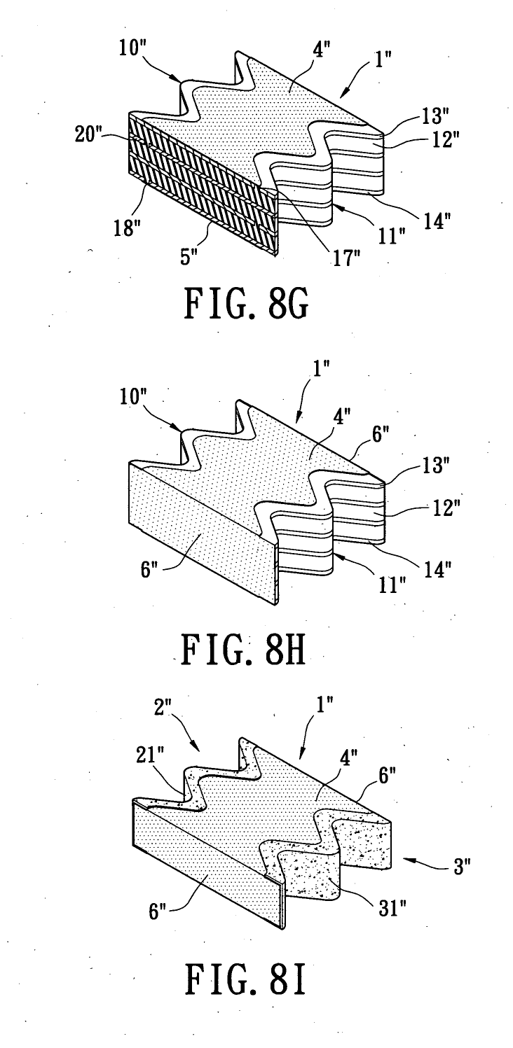

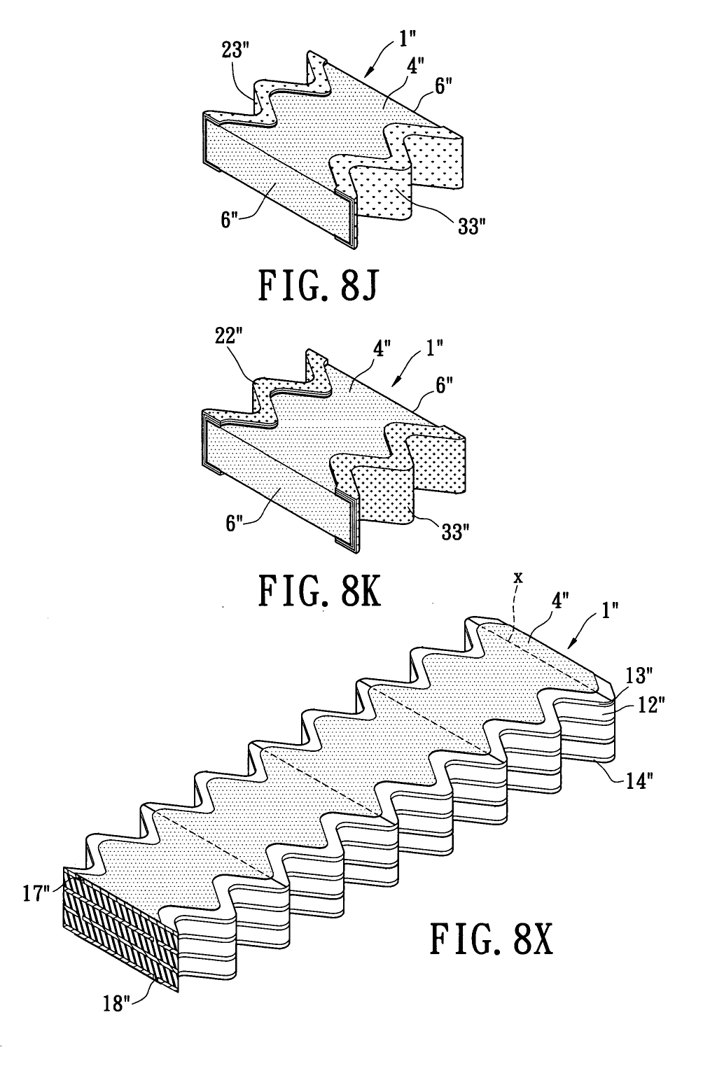

With reference to FIG. 7, at least two methods for producing a resetable over-current protection device are provided. The first method, referring to FIGS. 8A to 8K, and FIG. 8X, includes the following steps.

(a) Single sheet lamination: Referring to FIGS. 8A and 8B, a laminated body is prepared, which is formed first by pressing at least two conductive polymeric sheets 12″ alternatingly with at least one inner electrode sheet 20″, and then, providing upper and lower outer electrode sheets 13″, 14″ disposed under and below the two conductive polymeric sheets 12″, respectively.

(b) Etching: The upper, lower outer electrode sheets 13″, 14″ and the inner electrode sheets 20″ are etched with a plurality of separation grooves 17″ respectively, which are discontinuous and curved at least one concave portion or at least one continuous concave-convex portion. The separation grooves 17″ alternate at the upper, lower outer electrode sheets 13″, 14″ and the inner electrode sheets 20″ in order to define a plurality of chip devices. The quantity of the concave or the continuous concave-convex portion can be determined by the chip size.

(c) Engraving in advance: As is illustrated in FIG. 8C, a plurality of lines is pre-cut corresponding to a predetermined pattern on each of the upper and lower outer electrode sheets 13″, 14″. The lines have a plurality of continuous longitudinal curves “y” and a plurality of discontinuous horizontal beelines “x”, and each of the continuous longitudinal curves “y” is symmetric to a neighboring one. Step (b) and (c) can be interchanged.

(d) Multilayered sheet: As is illustrated in FIGS. 8D and 8E, at least two laminated bodies and at least one conductive polymeric sheet 12″, which is sandwiched between the two laminated bodies, are prepared in order to form a laminated sheet 1″.

(e) LPSM coating: In accordance with FIG. 8F, two insulative sheets 4″ are coated on, covering the upper and lower outer electrode sheets 13″, 14″ of the laminated sheet 1″, and enclosing a respective uppermost one and a lowermost one of the separation grooves 17″.

(f) Dividing: With respect to FIG. 8G, the laminated sheet 1″ is segmented into a plurality of chip devices. Each of the chip devices has two lateral curved sidewalls 10″, 11″ symmetrical to each other. The dicing further includes punching the laminated sheet 1″ into the chip devices in a direct manner corresponding to the continuous longitudinal curves “y” and the discontinuous horizontal beelines “x”, or, corresponding to FIG. 8X, punching or dicing the laminated sheet 1″ into a plurality of strips corresponding to the continuous longitudinal curves “y”, and further dicing, punching or folding the strips into the chip devices corresponding to the discontinuous horizontal beelines “x”.

(g) Side coat: Two insulative walls are coated on a front and a rear of each respective chip device, as illustrated in FIG. 8H.

(h) Electroplating: With respect to FIGS. 8I to 8K, each of the chip devices is electroplated as two end terminals 2″ and 3″ attached to the two lateral curved sidewalls 10″ and 11″ thereof, for electrically connecting the inner electrode sheet 20″, upper and lower outer electrode sheets 13″ and 14″ in an alternating manner. An innermost layer is defined, which innermost layer is electroplated first as a first electroplated layer 21″, 31″ being a copper-plated or nickel-plated layer and defining an outermost layer that is electroplated finally as a tin-plated layer as a second electroplated layer 22″, 32″. The nickel-plated layer is formed between the first electroplated layer 21″, 31″ and the second electroplated layer 22″, 32″ while the first electroplated layer 21″, 31″ is the copper-plated layer. Step (g) can be omitted, because the current density is controlled in the electroplating process and the polymer sheets 12″ and the insulative sheets 4″, 5″ can be excluded for plating.

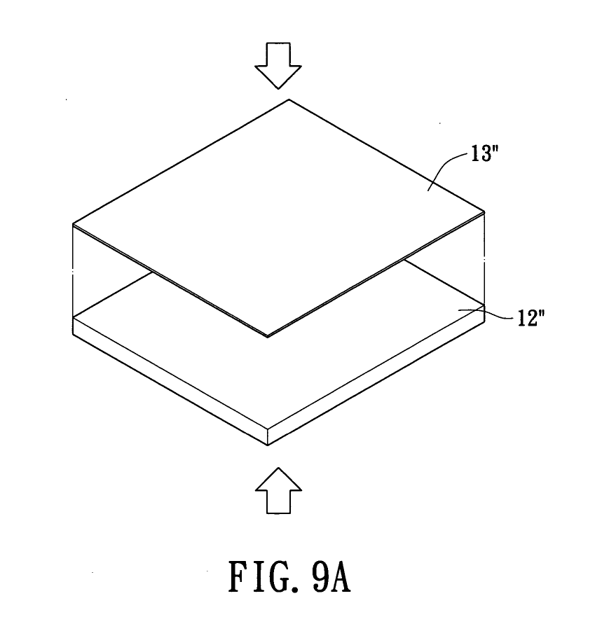

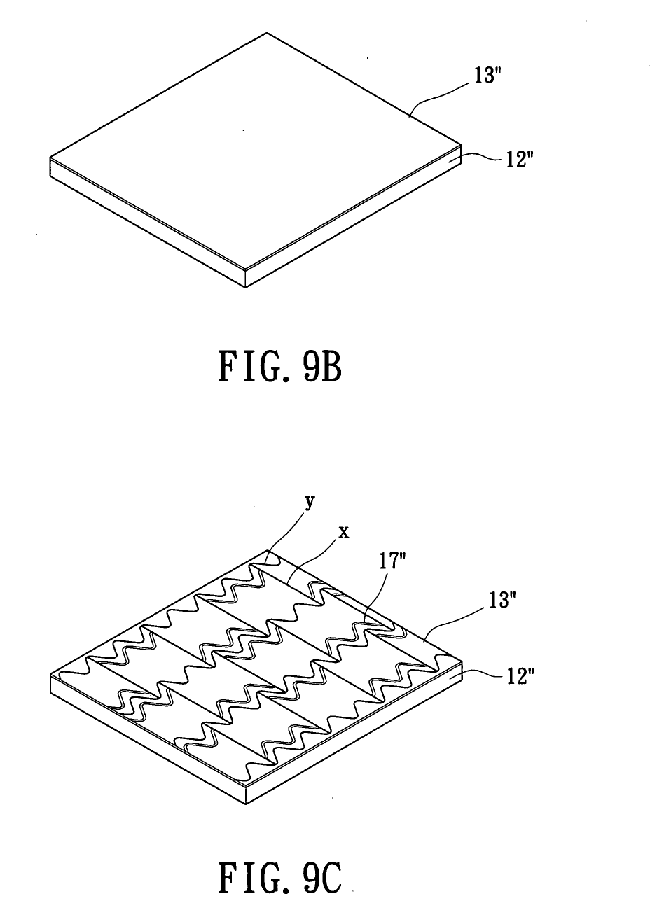

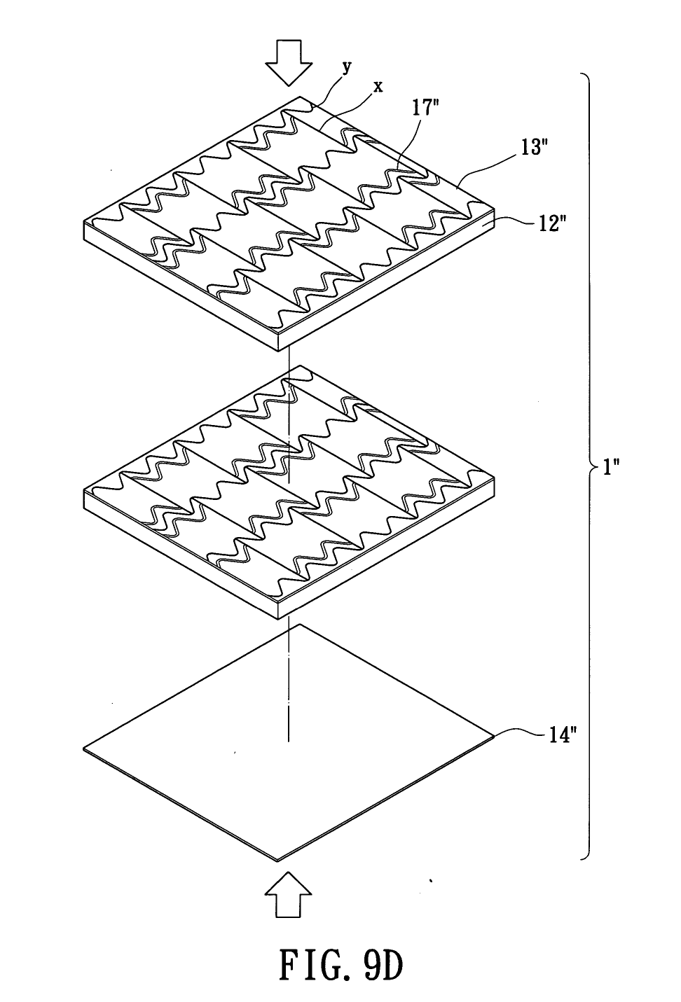

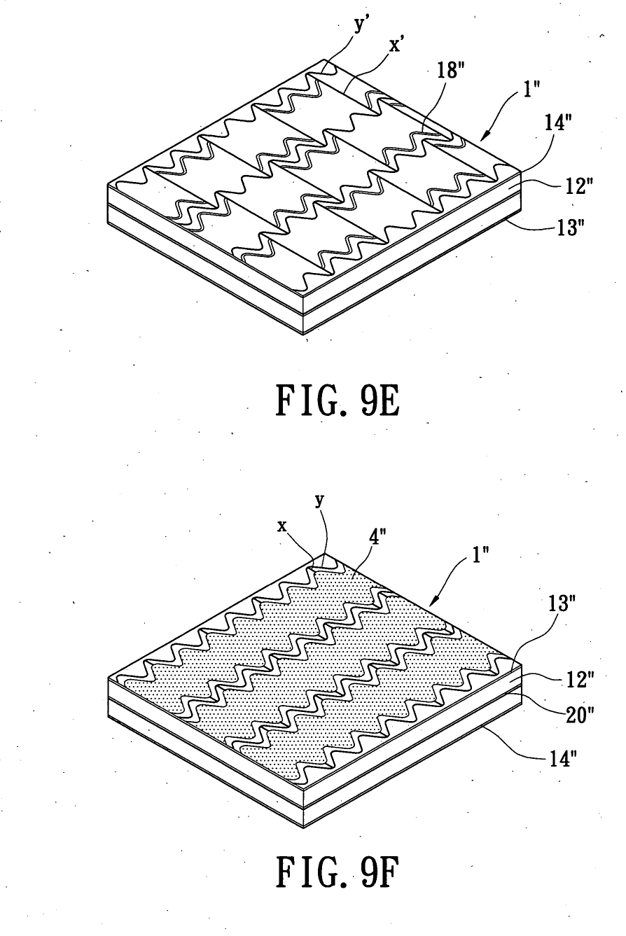

With reference to FIGS. 7 and 9A to 9F, the second method includes the following steps:

(a) Single sheet lamination: Referring to FIGS. 9A and 9B, a respective conductive polymeric sheet 12″ pressed by the electrode sheet 13″ as a laminated body is prepared.

(b) First etching: Referring to FIG. 9C, the electrode sheet 13″ is etched with a plurality of separation grooves 17″, which are discontinuous and curved at least one concave portion or at least one continuous concave-convex portion. The separation grooves 17″ are alternatingly arranged in order to define a plurality of chip devices. The quantity of the concave or the continuous concave-convex portion can be determined by the chip size.

(c) First engraving in advance: Referring to FIG. 9C, a plurality of lines is pre-cut corresponding to a predetermined pattern on the electrode sheets 13″. The lines have a plurality of continuous longitudinal curves “y” and a plurality of discontinuous horizontal beelines “x”, and each of the continuous longitudinal curves “y” is symmetric to a neighboring one.

(d) Multilayered sheet: As is illustrated in FIGS. 9D, at least two laminated bodies and an additional electrode sheet 14″ are stacked sequentially, in order to form the laminated sheet 1″.

(e) Second etching: Referring to FIG. 9E, the electrode sheet 14″ is etched with a plurality of separation grooves 17″, which have the same curvature as those formed in step (b).

(f) Second engraving in advance: Referring to FIG. 9E, a plurality of lines corresponding to the predetermined pattern on the electrode sheets 14″ is precut. The lines have continuous longitudinal curves “y” and discontinuous horizontal beelines “x”, each of the continuous longitudinal curves “y” is symmetric to a neighboring one, and the continuous longitudinal curves “y” of each sheet are alternatingly arranged. Steps (b) and (c) are interchangeable, and steps (e) and (f) are-interchangeable.

(g) LPSM coating: In accordance with FIG. 9F, two insulative sheets 4″ are coated on, covering the upper and lower outer electrode sheets 13″, 14″ of the laminated sheet 1″, and enclosing a respective uppermost one and a lowermost one of the separation grooves 17″.

Subsequent steps are same as those described with respect to the first method are not given in further detail here.

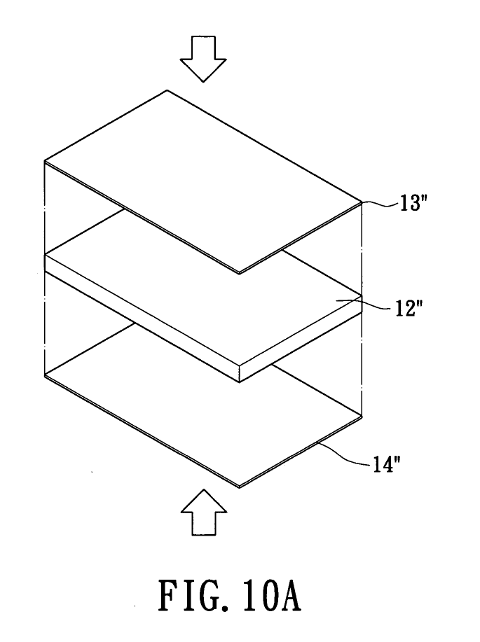

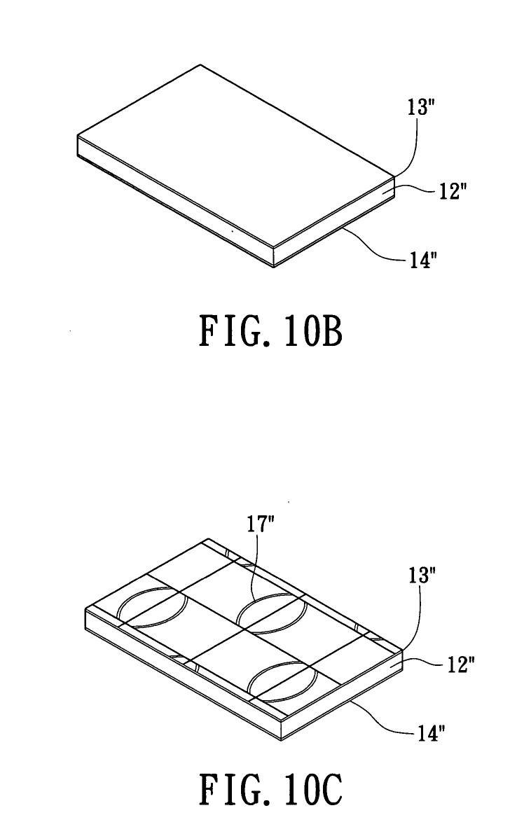

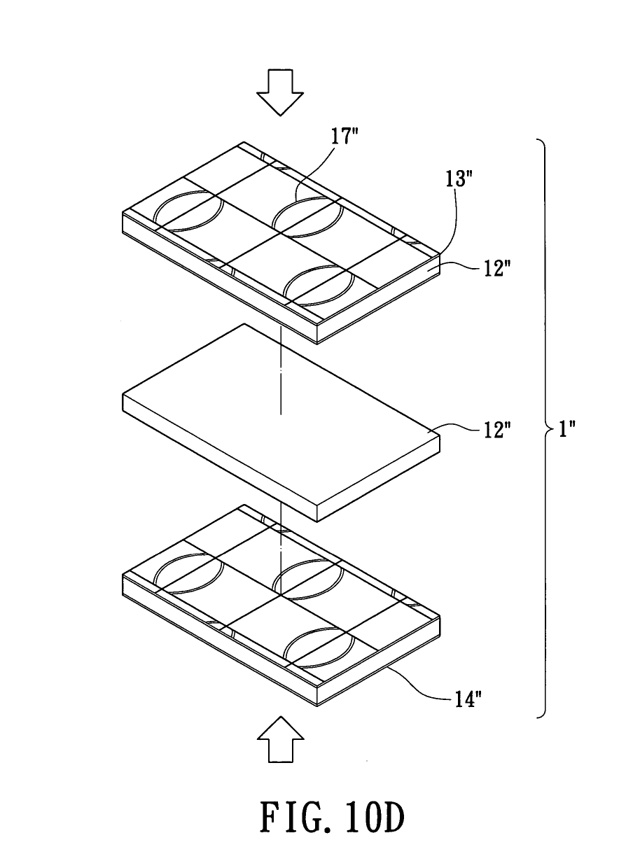

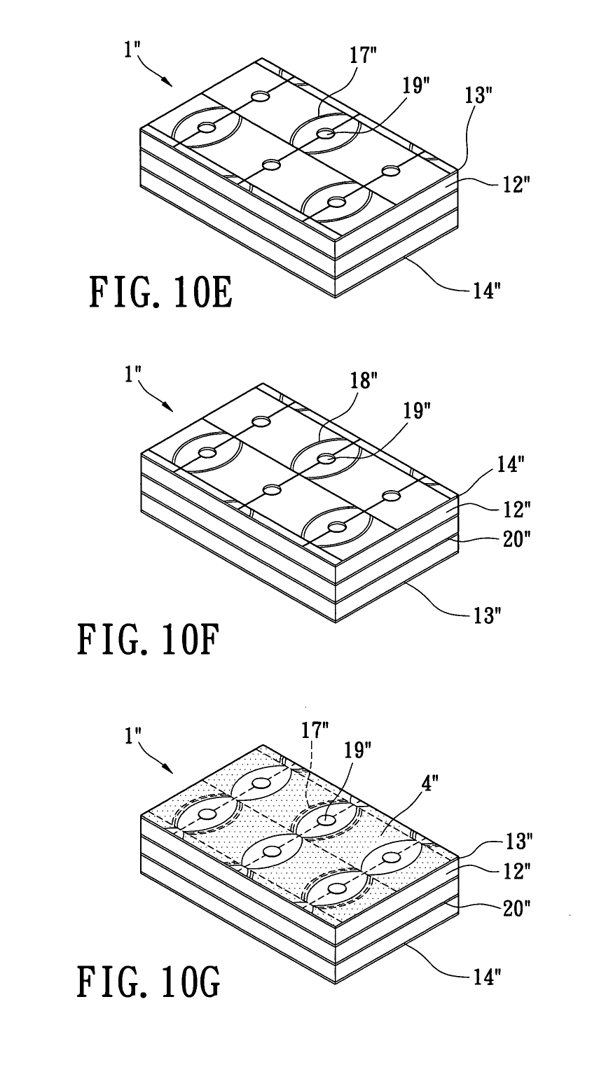

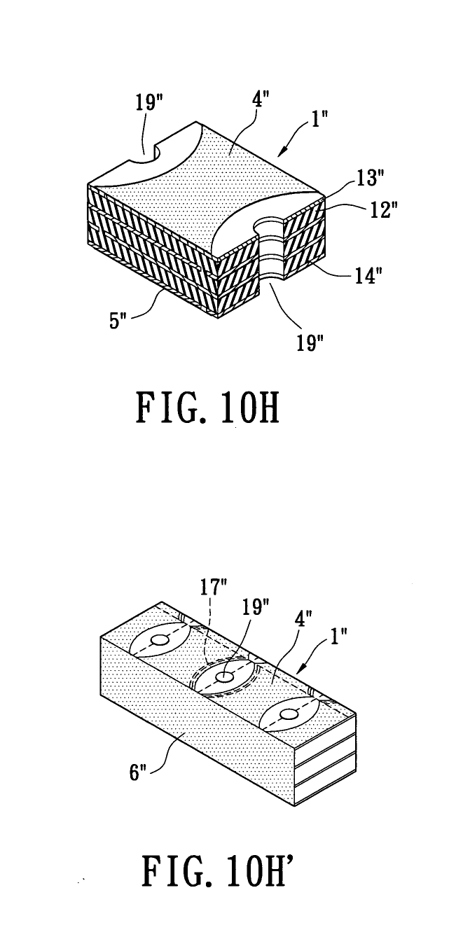

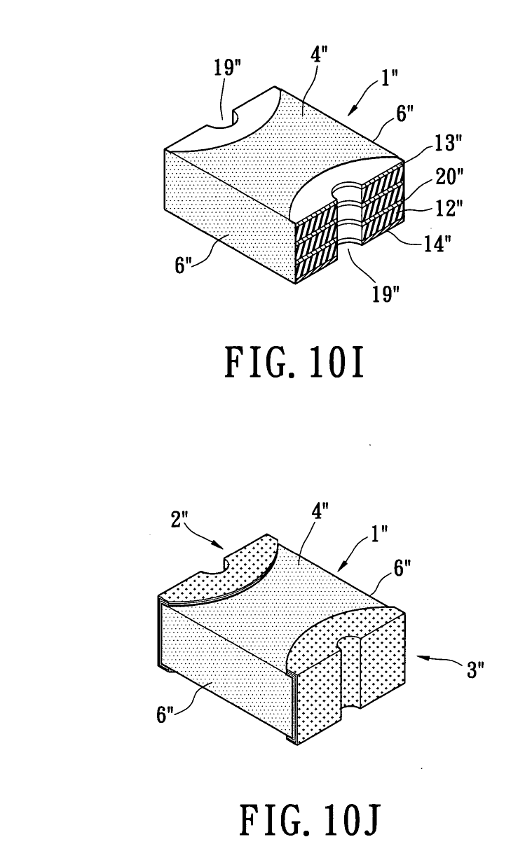

With reference to FIGS. 7, 10A to 10K, the third method includes the following steps.

(a) A respective conductive polymeric sheet 12″ pressed by the electrode sheet 13″ as a laminated body is prepared.

(b) First etching: Referring to FIG. 10C, the electrode sheet 13″ is etched with a plurality of separation grooves 17″, which are discontinuous and curved with one concave portion. The separation grooves 17″ are alternatingly arranged in order to define a plurality of chip devices.

(c) Multilayered sheet: As is illustrated in FIGS. 10D, at least two laminated bodies and an additional electrode sheet 14″ are stacked sequentially, in order to form the laminated sheet 1″.

(d) Hole drilling: With respect to FIG. 10F, a plurality of grid lines is pre-cut on the upper and lower outer electrode sheets 13″, 14″ of the laminated sheet 1″ corresponding to a predetermined pattern. A plurality of drilling holes 19″ penetrate through the laminated sheet 1″ corresponding to the predetermined pattern. Each of the drilled holes 19″ is located on an intersection point of the grid lines.

e) Second etching: Referring to FIG. 10F, the electrode sheet 14″ is etched with a plurality of separation grooves 17″, which have the same curvature as those etched in step (b).

(f) LPSM coating: In accordance with FIG. 10G, two insulative sheets 4″ are coated on, covering the upper and lower outer electrode sheets 13″, 14″ of the laminated sheet 1″, and enclosing a respective uppermost one and a lowermost one of the separation grooves 17″.

(g) Dividing: With respect to FIG. 10H, the laminated sheet 1″ is segmented into a plurality of chip devices. Each of the chip devices has two lateral curved sidewalls 10″, 11″ symmetrical to each other. The dicing further includes punching the laminated sheet 1″ into the chip devices in a direct manner or, referring to FIG. 10′, punching or dicing the laminated sheet 1″ into a plurality of strips and further dicing, punching or folding the strips into the chip devices, so that each chip device includes two drilling surfaces opposite to each other and corresponding to the drilling holes 19″.

(h) Side coat: Two insulative walls are coated on a front and a rear of each respective chip device, as illustrated in FIG. 10I.

(i) Electroplating: With respect to FIG. 10J, each of the chip devices is electroplated as two end terminals 2″ and 3″ attached to the two lateral curved sidewalls 10″ and 11″ of each chip device.

Subsequent steps and embodiments are the same as those described with respect to the first method and no further details are given here. In addition, step (g) can be omitted, because the current density is controlled in the electroplating process and the polymer sheets 12″ and the insulative sheets 4″, 5″ can be excluded for plating, as in the first method.

Therefore, the advantages according to the present invention include:

1. Resolving the problems due to heat cluster by curved surface areas, which can improve the heat conductivity, the fineness of electroplating process and the solderability of soldering step.

2. Utilizing symmetrical curved sides thereof to balance the inner stresses to prevent component cracking.

3. The upper and lower outer electrode sheets of the present device overlap with each other to form a larger effective area, by corresponding to the curved sides, than that of a conventional device with the same chip size.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A resettable over-current protection device comprising:
a laminated body, including at least two conductive polymeric sheets, at least one inner electrode sheet arranged between the two conductive polymeric sheets, and upper and lower outer electrode sheets disposed under and below the two conductive polymeric sheets, respectively, wherein the laminated body has two lateral curved sidewalls symmetrical to each other, and the two conductive polymeric sheets are characterized by a positive temperature coefficient;
two end terminals wrapping lateral sides of the curved sidewalls of the laminated body, and electrically connecting the inner electrode sheet, upper and lower outer electrode sheets in an alternating manner; and
two insulative sheets covering uppermost and lowermost surfaces of the laminated body and filled between the two end terminals;
wherein the upper and lower outer electrode sheets have lateral curved sides symmetrical to each other due to correspondence with the two lateral curved sidewalls.

2. The device as claimed in claim 1, wherein each of the two lateral curved sidewalls has at least one concave portion.

3. The device as claimed in claim 1, wherein each of the two lateral curved sidewalls has a continuous concave-convex portion.

4. The device as claimed in claim 1, further including a plurality of separation grooves formed between the inner electrode sheet and the two end terminals, and formed between the upper and lower outer electrode sheets and the two end terminals, wherein the separation grooves are arranged in an alternating manner, and the two insulative sheets cover a respective uppermost one and a lowermost one of the separation grooves, respectively.

5. The device as claimed in claim 1, wherein the two outer electrode sheets are made of nickel, copper, nickel-plated copper foil, or copper-nickel alloy materials.

6. The device as claimed in claim 1, wherein each of the two end terminals includes at least two electroplated layers, wherein an outermost layer thereof is made of tin material.

7. The device as claimed in claim 6, wherein the electroplated layers have an innermost layer made of copper or nickel material.

8. The device as claimed in claim 1, wherein the two insulative sheets are made of liquid photoimagible solder mask (LPSM) inks.

9. The device as claimed in claim 1, wherein each of the two insulative sheets is coated along the two lateral curved sidewalls of the laminated body, so as to have lateral curved sides symmetrical to each other due to the correspondence with the two lateral curved sidewalls.

10. The device as claimed in claim 1, further including two insulative walls coated on a front and a rear of the laminated body, respectively.

11. The device as claimed in claim 10, wherein the two insulative walls are made of liquid photoimagible solder mask (LPSM) inks.

12. A method for producing resettable over-current protection device, comprising:
preparing a laminated sheet, wherein the laminated sheet is formed first by pressing at least two conductive polymeric sheets alternatingly with at least one inner electrode sheet, then providing upper and lower outer electrode sheets disposed under and below the two conductive polymeric sheets, respectively, and etching the upper, lower outer electrode sheets and the inner electrode sheets with a plurality of separation grooves, respectively, wherein the separation grooves are curved and discontinuous and the separation grooves alternate at the upper, lower outer electrode sheets and the inner electrode sheets; in order to define a plurality of chip devices;
pre-cutting a plurality of lines corresponding to a predetermined pattern on each of the upper and lower outer electrode sheets, wherein the lines have a plurality of continuous longitudinal curves and a plurality of discontinuous horizontal beelines, and each of the continuous longitudinal curves is symmetric to a neighboring curve;
coating two insulative sheets covering the upper and lower outer electrode sheets of the laminated sheet, and enclosing a respective uppermost one and a lowermost one of the separation grooves;
segmenting the laminated sheet into a plurality of chip devices, wherein each of the chip devices has two lateral curved sidewalls symmetrical to each other; and
electroplating each of the chip devices as two end terminals attached to the two lateral curved sidewalls thereof, for electrically connecting the inner electrode sheet, upper and lower outer electrode sheets in an alternating manner.

13. The method as claimed in claim 12, wherein the step of preparing the laminated sheet further includes:
sandwiching a respective one of the conductive polymeric sheets by two inner electrode sheets as a laminated body;
etching the two inner electrode sheets with a plurality of separation grooves, respectively; and
preparing at least two laminated bodies and at least one conductive polymeric sheet sandwiched between the two laminated bodies, in order to form a laminated sheet.

14. The method as claimed in claim 12, wherein the step of preparing the laminated sheet further includes:
preparing a respective one of the conductive polymeric sheets pressed by the inner electrode sheet as a laminated body;
etching the inner electrode sheet with a plurality of separation grooves;
stacking at least two laminated bodies and an additional inner electrode sheet sequentially, in order to form a laminated sheet; and
etching the additional inner electrode sheet with a plurality of separation grooves.

15. The method as claimed in claim 12, wherein each of the two lateral curved sidewalls has at least one concave portion.

16. The method as claimed in claim 12, wherein each of the two lateral curved sidewalls has at least one continuous concave-convex portion

17. The method as claimed in claim 12, wherein the step of segmenting the laminated sheet into the chip devices further includes:
punching the laminated sheet into the chip devices in a direct manner corresponding to the continuous longitudinal curves and the discontinuous horizontal beelines.

18. The method as claimed in claim 12, wherein the step of segmenting the laminated sheet into the chip devices further includes:
punching or dicing the laminated sheet into a plurality of strips corresponding to the continuous longitudinal curves; and
dicing, punching or folding the strips into the chip devices corresponding to the discontinuous horizontal beelines.

19. The method as claimed in claim 12, further including a step before the step of electroplating the chip devices, wherein:
two insulative walls are coated on a front and a rear of each respective chip device.

20. The method as claimed in claim 12, wherein the step of electroplating chip devices includes:
electroplating at least two layers on the two lateral curved sidewalls, and defining an innermost layer electroplated first as a first electroplated layer, wherein the innermost layer is a copper-plated or nickel-plated layer.

21. The method as claimed in claim 20, wherein the step of electroplating chip devices includes:
defining an outermost layer, wherein the outermost layer is electroplated as a tin-plated layer.

22. The method as claimed in claim 21, wherein the step of electroplating chip devices includes:
providing a nickel-plated layer formed between the copper-plated layer and the tin-plated layer when the first electroplated layer is the copper-plated layer.

23. A method for producing resettable over-current protection device, comprising:
preparing a laminated sheet, wherein the laminated sheet is formed first by pressing at least two conductive polymeric sheets alternatingly with at least one inner electrode sheet, then providing upper and lower outer electrode sheets disposed under and below the two conductive polymeric sheets, respectively, and etching the upper, lower outer electrode sheets and the inner electrode sheets with a plurality of separation grooves, respectively, wherein the separation grooves are curved and discontinuous and the separation grooves alternate at the upper, lower outer electrode sheets and the inner electrode sheets; in order to define a plurality of chip devices;
arranging a plurality of drilling holes penetrating through the laminated sheet corresponding to a predetermined pattern;
coating two insulative sheets covering the upper and lower outer electrode sheets of the laminated sheet, and enclosing a respective uppermost one and a lowermost one of the separation grooves;
segmenting the laminated sheet into a plurality of chip devices, wherein each of the chip devices has two lateral drilled surfaces symmetrical to each other; and
electroplating each of the chip devices as two end terminals attached to the two lateral curved sidewalls thereof, for electrically connecting the inner electrode sheet, upper and lower outer electrode sheets in an alternating manner.

24. The method as claimed in claim 23, wherein the step of arranging the drilling holes includes:
pre-cutting a plurality of grid lines on the upper and lower outer electrode sheets of the laminated sheet corresponding to the predetermined pattern, and each of the drilled holes is located on an intersection point of the grid lines.

25. The method as claimed in claim 23, wherein the step of preparing the laminated sheet further includes:
sandwiching a respective one of the conductive polymeric sheets by two inner electrode sheets as a laminated body;
etching the two inner electrode sheets with a plurality of separation grooves, respectively; and
preparing at least two laminated bodies and at least one conductive polymeric sheet sandwiched between the two laminated bodies, in order to form a laminated sheet.

26. The method as claimed in claim 23, wherein the step of preparing the laminated sheet further includes:
preparing a respective one of the conductive polymeric sheets pressed by the inner electrode sheet as a laminated body;
etching the inner electrode sheet with a plurality of separation grooves;
stacking at least two laminated bodies and an additional inner electrode sheet sequentially, in order to form a laminated sheet; and
etching the additional inner electrode sheet with a plurality of separation grooves.

27. The method as claimed in claim 24, wherein the step of segmenting the laminated sheet into the chip devices further includes:
punching the laminated sheet into the chip devices in a direct manner corresponding to the continuous longitudinal curves and the discontinuous horizontal beelines.

28. The method as claimed in claim 27, further including a step before the step of electroplating the chip devices, wherein:
two insulative walls are coated on a front and a rear of each respective chip device.

29. The method as claimed in claim 24, wherein the step of segmenting the laminated sheet into the chip devices further includes:
punching or dicing the laminated sheet into a plurality of strips corresponding to the continuous longitudinal curves; and
dicing, punching or folding the strips into the chip devices corresponding to the discontinuous horizontal beelines.

30. The method as claimed in claim 29, further including a step before the step of making the chip devices, having:
coating two insulative walls in a front and a rear of each respective strip.

31. The method as claimed in claim 29, further including a step before the step of electroplating the chip devices, having:
coating two insulative walls on a front and a rear of each respective chip device.

32. The method as claimed in claim 26, wherein the step of electroplating chip devices includes:
electroplating at least two layers on the two lateral curved sidewalls, and defining an innermost layer, wherein the innermost layer that is electroplated first as a first electroplated layer and is a copper-plated or nickel-plated layer.

33. The method as claimed in claim 32, wherein the step of electroplating chip devices includes:
defining an outermost layer, wherein the outermost layer is electroplated as a tin-plated layer.

34. The method as claimed in claim 33, wherein the step of electroplating chip devices includes:
providing a nickel-plated layer formed between the copper-plated layer and the tin-plated layer when the first electroplated layer is the copper-plated layer.
